(19) United States
(12) Patent Application Publication
(10) Pub. No.: US 2014/0278293 A1
(43) Pub. Date: Sep. 18, 2014

(54) METHODOLOGY FOR THE ANALYSIS OF MSLB AND TSV ACOUSTIC TRANSIENTS IN BWRS

(71) Applicant: WESTINGHOUSE ELECTRIC COMPANY LLC, CRANBERRY TOWNSHIP, PA (US)

(72) Inventor: Gianluca Longoni, Pittsburgh, PA (US)

(73) Assignee: WESTINGHOUSE ELECTRIC COMPANY LLC, CRANBERRY TOWNSHIP, PA (US)

(21) Appl. No.: 13/834,768

(22) Filed: Mar. 15, 2013

(51) Int. Cl. G06F 17/50

(52) U.S. Cl. CPC G06F 17/5009
USPC 703/2

(57) ABSTRACT

This invention relates to a new methodology to analyze the effects of the acoustic waves generated during accident or operational transients occurring in boiling water reactors (BWRs). These transients include the main steam line break (MSLB) event and the turbine stop valve (TSV) operational transient. Accordingly, the invention is utilized for calculating the dynamic loads on steam dryers of a boiling water reactor resulting from the main steam line break event or the turbine stop valve event.

### BACKGROUND OF THE INVENTION

1. Field of the Invention

The invention relates generally to fluid transients in a nuclear reactor power plant and, more particularly, to evaluating acoustic waves originating from fluid transients in the main steam lines of a boiling water reactor (BWR).

2. Background of the Invention

It is known in the art that acoustic waves can originate from fluid transients in the main steam lines of a boiling water reactor. Pressure pulses at sonic velocity can propagate throughout the main steam lines. The pressure pulses are related to rapid changes in flow conditions in the main steam lines, e.g., sudden system de-pressurization. The pressure fluctuations propagating in the main steam lines are acoustic in nature and they can propagate at the speed of sound of the medium in which they are confined, i.e., steam. In a boiling water reactor, the occurrence of a Main Steam Line Break (MSLB) event or a Turbine Stop Valve (TSV) event can result in a rapid change in the main steam line system pressure which can lead to generation of acoustic waves propagating throughout the main steam lines and reaching the reactor internals, in particular, the steam dryer. In the MSLB event, the rapid de-pressurization is observed due to a line break and in the TSV event, a pressure pulse is generated by the sudden closure of the turbine stop valves on all four lines of the boiling water reactor.

It is an object of the invention to develop a computational methodology to evaluate the acoustic waves originating from fluid transients in the main steam lines in a boiling water reactor as a result of a MSLB event or a TSV event.

It is another object of the invention to develop a computational methodology to calculate the dynamic loads on steam dryers of a boiling water reactor resulting from a MSLB event or a TSV event.

### SUMMARY OF THE INVENTION

In one aspect, the invention provides a computational method containing a mathematical model for determining a dynamic load, acoustic in nature, on the steam dryer of a boiling water reactor resulting from a fluid transient selected from a main steam line break event or a turbine stop valve event in a main steam line, wherein the boiling water reactor has four main steam lines, a pressure equalizer, a reactor pressure vessel and a steam dome. The method includes developing a network model of the main steam lines including the pressure equalizer, reactor pressure vessel and pipe segments for the main steam lines between junction points, and calculating an acoustic load generated by the fluid transient propagating in the main steam line. The acoustic load is calculated by: utilizing a frequency-based acoustic circuit model to determine pressure and velocity of the acoustic waves, solving a mass conservation equation for steam volume in the pressure equalizer and the reactor pressure vessel, introducing time-dependent behavior in the velocity and pressure of the acoustic waves, determining acoustic velocity for the main steam lines, and utilizing the acoustic velocity as a boundary condition on Helmholz solution of the steam dryer and surrounding fluid inside the steam dome.

The acoustic pressure of the acoustic wave is determined by Equation 1 as follows:

\hat{p}(x,ω)=ρa²[Aₙ(ω)e^{ik}^{₁ₙ}^{x}+Bₙ(ω)e^{ik}^{₂ₙ}^{x}]e^{iωt} (1)

wherein, \hat{p} represents spatially and frequency-dependent acoustic pressure, Aₙ(ω) and Bₙ(ω) are integration, ρ represents density, a represents speed of sound in steam, x is a position along the main steam lines, ω is angular frequency, index n distinguishes integration constants on each pipe segment for each main steam line and, k₁ₙ and k₂ₙ are roots of a dispersion Equation 3 as follows:

$${k}^{2} + i \frac{fU}{D} \frac{ω + Uk}{{a}^{2}} - {( \frac{ω + Uk}{\text{?}} )}^{2} = 0 \\ \text{?} \text{indicates text missing or illegible when filed} \qquad ( 3 )$$

wherein, f is friction factor, D is inner diameter of the steam line, U is mean steam flow velocity, and

wherein the roots of the dispersion equation are calculated for each main steam line.

The acoustic velocity of the acoustic wave is determined by Equation 2 as follows:

$$\hat{u} ( x , ω ) = [ - ( \frac{ω + {Uk}_{1 n}}{{k}_{1 n}} ) {A}_{n} {e}^{i {k}_{1 n} x} - ( \frac{ω + {Uk}_{2 n}}{{k}_{2 n}} ) {B}_{n} {e}^{i {k}_{2 n} x} ] {e}^{i ω t} \qquad ( 2 )$$

wherein, \hat{p} represents spatially and frequency-dependent acoustic pressure, Aₙ(ω) and Bₙ(ω) are integration, ρ represents density, a represents speed of sound in steam, x is a position along the main steam lines, ω is angular frequency, index n distinguishes integration constants on each pipe segment for each main steam line and, k₁ₙ and k₂ₙ are roots of a dispersion Equation 3 as follows:

$${k}^{2} + i \frac{fU}{D} \frac{ω + Uk}{{a}^{2}} - {( \frac{ω + Uk}{\text{?}} )}^{2} = 0 \\ \text{?} \text{indicates text missing or illegible when filed} \qquad ( 3 )$$

wherein, f is friction factor, D is inner diameter of the steam line, U is mean steam flow velocity, and

wherein the roots of the dispersion equation are calculated for each main steam line.

The steam volume in the pressure equalizer is calculated according to the following mass conservation equation:

$$V \frac{d P}{d t} = \sum {ρα}^{2} {Au}_{in} - \sum {ρα}^{2} {Au}_{out} \qquad ( 4 )$$

wherein, ρ represents density, a represents speed of sound in steam, ω is angular frequency, and A is an identifier for the main steam line where the fluid transient event occurs.

### BRIEF DESCRIPTION OF THE DRAWINGS

A further understanding of the invention claimed hereafter can be gained from the following description of preferred embodiments when read in conjunction with the accompanying drawings in which:

FIG. 1 is a schematic that shows a Main Steam Line Break Network Model, in accordance with certain embodiments of the invention;

FIG. 2 is a schematic that shows a Turbine Stop Valve Network Model, in accordance with certain embodiments of the invention;

FIG. 3 is a plot that shows a Main Steam Line Break Velocity Profile, in accordance with certain embodiments of the invention;

FIG. 4 is a plot that shows a Turbine Stop Valve Velocity Profile, in accordance with certain embodiments of the invention;

FIG. 5 is a schematic that shows component and junction data, in accordance with certain embodiments of the invention;

FIG. 6 is a plot that shows a comparison of pressure time histories for a Turbine Stop Valve Transient, in accordance with certain embodiments of the invention;

FIG. 7 is a plot that shows a comparison of pressure time histories for the Turbine Stop Valve Transient, in accordance with certain embodiments of the invention; and

FIG. 8 is a plot that shows a comparison of pressure time histories for the Turbine Stop Valve Transient, in accordance with certain embodiments of the invention.

### DESCRIPTION OF THE PREFERRED EMBODIMENTS

The invention relates to computational methods to evaluate fluid transients, leading to the generation of acoustic waves, in the main steam lines (MSLs) of a light water reactor, such as a boiling water reactor (BWR). Further, the invention includes a computational methodology to calculate the dynamic loads on steam dryers of a boiling water reactor resulting from a MSLB event or a TSV event. The methodology of the invention addresses the propagation of pressure pulses at sonic velocity throughout the main steam lines (MSLs) of a BWR. The origin of the pressure pulses is related to rapid changes in the flow conditions in the steam lines, e.g., sudden system de-pressurization. In the case of steady flow, there is no change in conditions at a point with time. However, in unsteady flow, conditions at a point may change with time. The methodology of the invention analyzes unsteady flow conditions and phenomena. In particular, these phenomena are generically characterized as waterhammer, or in the particular case of a BWR, as steamhammer. The pressure fluctuations propagating in the steam lines are acoustic in nature and they propagate at the speed of sound of the medium in which they are confined, i.e., steam.

The events which lead to steamhammer in a BWR and that are considered in the methodology of the invention are the Main Steam Line Break (MSLB) Event and the Turbine Stop Valve (TSV) Event.

Typically, the main steam system in a BWR includes four MSLs and four TSVs. For the MSLB event, a break is postulated to occur in one of the MSLs and steam is released. A TSV event involves the simultaneous closure of all four of these valves. Both transients involve a rapid change in the MSL system pressure leading to generation of acoustic waves propagating throughout the MSLs, reaching the reactor internals, and in particular the steam dryer. In the case of an MSLB event, a rapid de-pressurization is observed due to a line break, while in the case of a TSV event, a pressure pulse is generated by the sudden closure of the turbine stop valves on all four lines of a BWR.

During a postulated MSLB event, the rapid depressurization of the system due to the line break will generate a rarefaction wave that travels upstream from the break to the steam dryer. The other side of the break also generates an acoustic wave that will reach the steam dryer passing through the pressure equalizer, also referred to as “D-ring” for certain nuclear plants.

For a TSV type of transient, a sudden closure of the four turbine isolation valves is postulated to occur. The sudden closure of the valves generates a system of acoustic waves which are compressive in nature, as compared to the MSLB transient wherein acoustic waves travel upstream in the MSLs and eventually reach the steam dryer.

These MSLB and TSV transients are analyzed by the methodology of the invention based on a modification of acoustic circuit equations utilized to analyze acoustic waves originating from flow induced vibration (FIV) phenomena. In accordance with the invention, the methodology developed for these transients is implemented in a computer code, named CHRONOS.

The mathematical model utilized in the invention is based on a one-dimensional (1-D) treatment of the acoustic pressure waves in the MSLs and, on a three-dimensional (3-D) treatment of the steam dryer and surrounding fluid inside the steam dome of the reactor.

The 1-D model is applicable provided that the wavelengths are greater than the characteristic dimensions of the system. For typical BWR applications, the acoustic loads are computed up to 250 Hz which corresponds to a wavelength of approximately 7 feet assuming a speed of sound of 1600 ft/sec in steam. This quantity is larger than the characteristic dimension of the steam lines. In this case, the inside diameter (ID) is approximately 2 feet.

The acoustic circuit equations consider the propagation of the acoustic wave through the MSL at speed of sound of the medium under consideration, i.e., steam. Referring to FIG. 1, there is shown a network model developed for the MSLB event, in accordance with certain embodiments of the invention. The network model includes the reactor pressure vessel steam volume, MSLs A, B, C and D, junctions P1, P2 and P3, and a pressure equalizer volume. A change in diameter of the pipe can occur at junction P2. A line break is shown to occur in MSL A at a location just outside containment and downstream of the outboard main steam isolation valve (both not shown).

Referring to FIG. 2, there is shown a network model for the TSV event, in accordance with certain embodiments of the invention. The network includes a pressure vessel, a pressure equalizer, junctions P1, P2, P3, and P4, and four turbine stop valves. Similarly to the MSLB event, a change in diameter can occur at junction P2.

The pressure and velocity of the acoustic wave can be determined as follows:

$$\begin{matrix}\hat{p} ( x , ω ) = ρ {a}^{2} [ {A}_{n} ( ω ) {e}^{i {k}_{1 n} x} + {B}_{n} ( ω ) {e}^{i {k}_{2 n} x} ] {e}^{iω t} & ( 1 ) \\ \hat{u} ( x , ω ) = [ - ( \frac{ω + {Uk}_{1 n}}{{k}_{1 n}} ) {A}_{n} {e}^{i {k}_{1 n} x} - ( \frac{ω + {Uk}_{2 n}}{{k}_{2 n}} ) {B}_{n} {e}^{i {k}_{2 n} x} ] {e}^{iω t} & ( 2 )\end{matrix}$$

wherein, \hat{p} and û represent the spatially and frequency-dependent acoustic pressure and velocity, respectively, Aₙ(ω) and Bₙ(ω) are integration constants obtained by applying the appropriate boundary conditions for the transient under consideration, i.e., MSLB or TSV, ρ represents the density in lbm/ft³, a represents the speed of sound in the medium (steam), x is the position along the MSL, ω is the angular frequency and, k₁ₙ and k₂ₙ are the roots of the dispersion. In the following Equation 3 the roots of the dispersion equation are calculated for each MSL and for each pipe segment. For the MSLB and TSV network models, the index n is used to distinguish the integration constants on each pipe segment for each MSL.

$${k}^{2} + i \frac{fU}{D} \frac{ω + Uk}{{a}^{2}} - {( \frac{ω + Uk}{\text{?}} )}^{2} = 0 \\ \text{?} \text{indicates text missing or illegible when filed} \qquad ( 3 )$$

wherein f is the friction factor consistent with the Darcy-Weisbach model, D is the inner diameter of the steam line, U is the mean steam flow velocity. Therefore, the roots of Equation 3 are obtained for each specific segment in the MSLs (as shown in FIGS. 1 and 2), where a diameter variation may occur.

The mathematical model developed for the MSLB and TSV loads is defined as a lumped-parameter network model where the acoustic equations (Equations 1 and 2) are used to represent the acoustic pressure and velocity inside the lines as 1-D circuit elements. The steam volume in the reactor pressure vessel (RPV) is addressed using a mass conservation equation, resulting in a zero-dimensional (0-D) acoustic element.

The steam volume in the pressure equalizer, if present for the nuclear plant under analysis, is also modeled using a 0-D acoustic element similarly to the RPV. The following Equation 4 represents the generic mass conservation equation for the steam volumes considered in the model. The MSLB is postulated to occur on MSL A. However, this selection is not limiting of the approach because any of the other MSLs may be selected.

$$V \frac{d P}{d t} - \sum ρ {a}^{2} {Au}_{in} - \sum ρ {a}^{2} {Au}_{out} \qquad ( 4 )$$

The MSLB load definition for a BWR considers the following scenarios:

Related Core Power and Core Flow Conditions:

MSLBDP1—considers the differential pressure load in the faulted condition due to a MSL outside containment at the rated core power and core flow conditions; and

MSLBA1—considers the acoustic load in the faulted condition due to a MSLB outside containment at the rated core power and core flow conditions.

Low Power/High Core Flow Conditions:

MSLBDP2—considers the differential pressure load in the faulted condition due to a MSL outside containment at the low power/high core flow conditions; and

MSLBA2—considers the acoustic load in the faulted condition due to a MSLB outside containment at the low power/high core flow conditions.

The total MSLB load consists of an acoustic component which is the most severe and dominates the initial part of the transient, and of a quasi-steady state drag load due to the dynamic pressure imparted on the steam dryer by the steam exiting the break. The methodology of the invention addresses the acoustic portion of the loads generated during an MSLB event. The acoustic load in the first instance of an MSLB event consists of a rarefaction wave which is generated at the break location and travels in the MSLs at the speed of sound in the medium, i.e., steam. Referring to FIG. 1, the MSLB acoustic transient solution consists of finding the A and B integration constants in Equations 1 and 2 for the four MSLs, i.e., A, B, C and D, in each pipe segment located between the junctions, i.e., from P1 to P2 and from P2 to P3. There are a total of 16 coefficients, two per each pipe segment on each MSL and therefore, 16 equations are required to mathematically close and solve the problem. These equations are as follows:

One equation for the mass conservation equation applied to the reactor pressure vessel;

Three equations for the pressure continuity at the reactor pressure vessel for MSLs B, C, and D;

Six equations for the mass and pressure continuity at junction P2 for MSLs B, C, D;

One equation for the mass conservation equation applied to the pressure equalizer; and

Three equations for the pressure continuity at junction P3 for MSLs B, C, and D.

This is a total of 14 equations. The additional two equations required to mathematically close and solve the problem involve the definition of the velocity profile at the location of the line break on the pressure vessel side for MSL A. The velocity profile is defined as a linear change in the steam velocity from normal operating conditions to the velocity achieved after the break. The velocity profile is also specified at the break on the turbine side, therefore, mathematically closing the problem.

Referring to FIG. 2, the TSV acoustic transient solution consists of finding the A and B integration constants in Equations 1 and 2 for the four MSLs A, B, C and D in each pipe segment located between the junctions, i.e., from P1 to P2, from P2 to P3, and from P4 to P5. The same equations used for the MSLB transient are used to develop the TSV transient mathematical model. The mathematical model can be explained by considering one MSL and applying the same set of equations to the other MSLs (potentially with different geometrical parameters, e.g., pipe lengths).

The RPV is considered a 0-D acoustic element and is addressed with a mass conservation equation. Pressure and mass continuity is similarly addressed at junction P2. At junction P3, the pressure equalizer is described by a mass conservation relationship as the RPV. Pressure continuity is addressed at junction P4, while the isolation valve closure transient is described by a modification of the velocity profile based on a ramp function, similar to the MSLB model. This is a total of six integration constants for one steam line and therefore, a total of 24 equations are required for the solution of the problem on four main steam lines.

Referring to FIG. 3, there is illustrated a time-history of a velocity profile for a MSLB event. The velocity profile at the line break is defined as a ramp function from the steady state MSL velocity to the break velocity. The time-history of the velocity profile is Fourier-transformed in the frequency domain in order to use the frequency-based acoustic circuit equations. The conventional methods known in the art are typically based on the solution of a time-dependent wave equation. In the invention, the sampling rate utilized is 2500 sample/sec which is adequate for this type of transient. Acoustic loads up to 250 Hz are included in the Fourier decomposition. However, it is understood that higher frequencies can be considered in the analysis in accordance with certain embodiments of the invention. In FIG. 3, due to the very steep gradient involved, the slope of the ramp function is not discernible and the MSLB event is postulated to occur at 10 seconds into the transient.

This methodology is generally applicable for use in modeling the MSLB from the turbine side. At this location, the velocity will increase from steady state operational conditions to three times the break velocity. This is due to the three MSLs B, C, and D discharging into the pressure equalizer steam volume and to the line break. The two velocity profiles at the break location complete the 16 equations required to solve the problem.

Following calculation of the coefficients A and B for each MSL, the acoustic velocity is obtained at the MSL A, B, C, and D inlets and specified as a boundary condition on a Helmholtz solution inside the steam dome. This methodology yields a complete acoustic load distribution around the steam dryer due to an MSLB event.

The methodology employed for evaluating the MSLB can be modified to analyze a turbine stop valve (TSV) acoustic transient. Referring to FIG. 4, there is illustrated a time-history of a velocity profile for a TSV event. This methodology can be used to predict the solutions for a benchmark problem. It is an objective of the invention to validate the acoustic parameters required by the MSLB and TSV methods, such as speed of sound, acoustic damping, and pipe friction factor.

Referring to FIG. 5, there is illustrated a component and junction geometry for a steam hammer transient due to closure of a main turbine stop valve in a simplified main steam system. Only one main steam line is considered. Input data is used to model the TSV transient.

Referring to FIGS. 6, 7, and 8 the acoustic solutions obtained with the methodology of the invention is compared to measured plant data at locations P1, P2, and P3 on the network shown in FIG. 5. The time-history solutions of the acoustic pressure calculated with the TSV methodology of the invention are shown in FIGS. 6, 7, and 8, at locations P1, P2 and P3, respectively. As shown in FIGS. 6, 7, and 8, the methodology of the invention is accurate in representing the pressure behavior of the system. Further, the methodology of the invention accurately captures the dominating pressure peak occurring between 0.1 and 0.2 seconds at locations P1 and P2, and the pressure gradient is well represented at approximately 0.6 sec at all three locations. At location P3, the pressure behavior is also accurately tracked by the methodology of the invention. This agreement exhibited by the TSV transient analysis indicates that the equations and the acoustic parameters implemented in the MSLB and TSV methodologies of the invention are effective for use in evaluating transients in MSLs of a BWR.

While specific embodiments of the invention have been described in detail, it will be appreciated by those skilled in the art that various modifications and alternatives to those details could be developed in light of the overall teachings of the disclosure. Accordingly, the particular embodiments disclosed are meant to be illustrative only and not limiting as to the scope of the invention which is to be given the full breadth of the appended claims and any and all equivalents thereof.

What is claimed is:

1. A computational method containing a mathematical model for determining a dynamic load, acoustic in nature, on the steam dryer of a boiling water reactor resulting from a fluid transient selected from a main steam line break event or a turbine stop valve event in a main steam line, wherein the boiling water reactor has four main steam lines, a pressure equalizer, a reactor pressure vessel and a steam dome; the method comprising
developing a network model of the main steam lines including the pressure equalizer, reactor pressure vessel and pipe segments for the main steam lines between junction points,
calculating an acoustic load generated by the fluid transient propagating in the main steam lines, comprising:
utilizing a frequency-based acoustic circuit model to determine pressure and velocity of the acoustic waves;
solving a mass conservation equation for steam volume in the pressure equalizer and the reactor pressure vessel;
introducing time-dependent behavior in the velocity and pressure of the acoustic waves;
determining acoustic velocity for the main steam lines; and
utilizing the acoustic velocity as a boundary condition on a Helmholz solution of the steam dryer and surrounding fluid inside the steam dome.

2. The method of claim 1, wherein the pressure of the acoustic wave is determined by Equation 1 as follows:
\hat{p}(x,ω)=ρa²[Aₙ(ω)e^{ik}^{₁ₙ}^{x}+Bₙ(ω)e^{ik}^{₂ₙ}^{x}]e^{iωt} (1)
wherein, \hat{p} represents spatially and frequency-dependent acoustic pressure, Aₙ(ω) and Bₙ(ω) are integration, ρ represents density, a represents speed of sound in steam, x is a position along the main steam lines, ω is angular frequency, index n distinguishes integration constants on each pipe segment for each main steam line and, k₁ₙ and k₂ₙ are roots of a dispersion Equation (3) as follows:
$${k}^{2} + i \frac{fU}{D} \frac{ω + Uk}{{a}^{2}} - {( \frac{ω + Uk}{\text{?}} )}^{2} = 0 \\ \text{?} \text{indicates text missing or illegible when filed} \qquad ( 3 )$$
wherein, f is friction factor, D is inner diameter of the steam line, U is mean steam flow velocity, and
wherein the roots of the dispersion equation are calculated for each main steam line.

3. The method of claim 1, wherein the velocity of the acoustic wave is determined by Equation 2 as follows:
$$\hat{u} ( x , ω ) = [ - ( \frac{ω + {Uk}_{1 n}}{{k}_{1 n}} ) {A}_{n} {e}^{i {k}_{1 n} x} - ( \frac{ω + {Uk}_{2 n}}{{k}_{2 n}} ) {B}_{n} {e}^{i {k}_{2 n} x} ] {e}^{iω t} \qquad ( 2 )$$
wherein, û represents spatially and frequency-dependent acoustic pressure, Aₙ(ω) and Rₙ(ω) are integration, ρ represents density, a represents speed of sound in steam, x is a position along the main steam lines, ω is angular frequency, index n distinguishes integration constants on each pipe segment for each main steam line and, k₁ₙ and k₂ₙ are roots of a dispersion Equation (3) as follows:
$${k}^{2} \vert i \begin{matrix}fU & ω + Uk \\ D & {a}^{2}\end{matrix} {( \begin{matrix}ω + Uk \\ a\end{matrix} )}^{2} = 0 \qquad ( 3 )$$
wherein, f is friction factor, D is inner diameter of the steam line, U is mean steam flow velocity, and
wherein the roots of the dispersion equation are calculated for each main steam line.

4. The method of claim 1, wherein steam volume in the pressure equalizer is calculated in accordance with a mass conservation equation as follows:
$$V \frac{d P}{d t} = \sum ρ {a}^{2} {Au}_{in} - \sum ρ {a}^{2} {All}_{out} \qquad ( 4 )$$
wherein, ρ represents density, a represents speed of sound in steam, ω is angular frequency, and A is an identifier for the main steam line wherein the fluid transient event occurs.
